(19) United States
(12) Patent Application Publication
(10) Pub. No.: US 2019/0242552 A1
(43) Pub. Date: Aug. 8, 2019

(54) LIGHTING APPARATUS

(71) Applicant: OPPLE LIGHTING CO., LTD., Shanghai (CN)

(72) Inventor: Chaobo LIU, Shanghai (CN)

(73) Assignee: OPPLE LIGHTING CO., LTD., Shanghai (CN)

(21) Appl. No.: 16/386,128

(22) Filed: Apr. 16, 2019

Related U.S. Application Data
(63) Continuation of application No. PCT/CN2017/106583, filed on Oct. 17, 2017.

(30) Foreign Application Priority Data
Oct. 26, 2016 (CN) 201610948477.1
Oct. 26, 2016 (CN) 201621172757.X
Oct. 26, 2016 (CN) 201720157275.5
Jan. 23, 2017 (CN) 201710057123.2
Jan. 23, 2017 (CN) 201720090222.6
Feb. 21, 2017 (CN) 201710093145.4
May 26, 2017 (CN) 201710385278.9
May 26, 2017 (CN) 201720604819.8

(51) Int. Cl. F21V 7/04; F21V 29/70; F21V 29/503; F21V 23/00; F21V 7/00; F21V 15/01; F21V 29/508

(52) U.S. Cl. CPC F21V 7/041; F21V 29/70; F21V 29/503; F21Y 2115/10; F21V 7/0025; F21V 15/01; F21V 29/508; F21V 23/006

(57) ABSTRACT

The present disclosure discloses a lighting apparatus, including a lamp body, an optical element connected with the lamp body, a driving power source assembly, a light source assembly and a reflecting device configured to provide a secondary light distribution for the light source assembly which are received in the lamp body; the reflecting device is provided with a light inlet, a light outlet and a reflecting wall located between the light inlet and the light outlet; the reflecting wall is transparent, and includes an internal surface and an external surface; the internal surface includes a plurality of saw-tooth structures, each of the saw-tooth structures includes a first refracting surface and a second refracting surface intersected with each other, two ends of each of the saw-tooth structures extend towards the light inlet and the light outlet; and the light source assembly is disposed at the light inlet of the reflecting device.

### CROSS-REFERENCE TO RELATED APPLICATIONS

This application is based upon and claims the priority of PCT patent application No. PCT/CN2017/106583 filed on Oct. 17, 2017 which claims the priority of Chinese Patent Application No. 201610948477.1 filed on Oct. 26, 2016, Chinese Patent Application No. 201710057123.2 filed on Jan. 23, 2017, Chinese Patent Application No. 201710093145.4 filed on Feb. 21, 2017, Chinese Patent Application No. 201720157275.5 filed on Oct. 26, 2016, Chinese Patent Application No. 201710385278.9 filed on May 26, 2017, Chinese Patent Application No. 201621172757.X filed on Oct. 26, 2016, Chinese Patent Application No. 201720090222.6 filed on Jan. 23, 2017 and Chinese Patent Application No. 201720604819.8 filed on May 26, 2017, the entire content of all of which is hereby incorporated by reference herein for all purposes.

### TECHNICAL FIELD

The present disclosure relates to the field of lighting technology, and particularly to a lighting apparatus.

### BACKGROUND

Electroplated reflectors are widely applied in commercially used lamps, for example, in illumination lamps such as downlight lamp, spotlight lamp, ceiling lamp and outdoor lamp. The electroplated reflector mainly functions as providing a secondary light distribution for light emitted from a light source. The electroplated reflector generally includes a reflecting surface plated with a layer of metallic film. However, a coating material typically has a relatively higher absorptivity to light, for example, a loss ratio resulted by an electroplated argentum (Ag) film is 5%, a loss ratio resulted by an electroplated aurum (Au) film is 9%, and a loss ratio resulted by an electroplated aluminum (Al) film even reaches up to 12%, which leads to a poor luminous efficiency of the lamp using an electroplated reflector.

### SUMMARY

The present disclosure provides a lighting apparatus and a method of manufacturing a lighting apparatus.

According to one aspect, the present disclosure provides a lighting apparatus. The lighting apparatus may include a lamp body, an optical element connected with the lamp body, a light source assembly received in the lamp body, a reflecting device received in the lamp body and configured to provide a secondary light distribution for the light source assembly, and a driving power source assembly received in the lamp body and electrically connected with the light source assembly; where the reflecting device is provided with a light inlet, a light outlet and a reflecting wall located between the light inlet and the light outlet; the reflecting wall is transparent, and the reflecting wall includes an internal surface and an external surface.

The internal surface of the lighting apparatus may include a plurality of saw-tooth structures arranged continuously; each of the saw-tooth structures includes a first refracting surface and a second refracting surface intersected with each other; two ends of each of the saw-tooth structures extend towards the light inlet and the light outlet; and the light source assembly may be disposed at the light inlet of the reflecting device.

According to a second aspect, a method of manufacturing a lighting apparatus is provided. The method may include providing a lamp body; connecting an optical element the lamp body; receiving a light source assembly in the lamp body; receiving a reflecting device in the lamp body, where the reflecting device is configured to provide: a light distribution for the light source assembly, and a driving power source assembly received in the lamp body and electrically connected with the light source assembly.

The method may also include providing the reflecting device with a light inlet, a light outlet and a reflecting wall located between the light inlet and the light outlet, where the reflecting wall is transparent, and the reflecting wall comprises an internal surface and an external surface, where the internal surface may include a plurality of saw-tooth structures arranged continuously, each of the saw-tooth structures may include a first refracting surface and a second refracting surface intersected with each other, and two ends of each of the saw-tooth structures extend towards the light inlet and the light outlet; and disposing the light source assembly at the light inlet of the reflecting device.

It is to be understood that both the foregoing general description and the following detailed description are exemplary and explanatory only and are not restrictive of the present disclosure.

### BRIEF DESCRIPTION OF THE DRAWINGS

The accompanying drawings described herein are provided for further understanding of the present disclosure, and constitute a part of the present disclosure. Examples of the present disclosure and descriptions thereof are used for the purpose of explaining the present disclosure, and are not to be construed as any improper limitation to the present disclosure. In the accompanying drawings:

FIG. 1 is a perspective view of a lighting apparatus provided by a first example of the present disclosure;

FIG. 2 is an exploded view of the lighting apparatus in FIG. 1;

FIG. 3 is an exploded view of the lighting apparatus in FIG. 1 from another viewing angle;

FIG. 4 is a perspective view of a reflecting device in the lighting apparatus provided by the first example of the present disclosure;

FIG. 5 is a sectional view taken along A-A line in FIG. 1;

FIG. 6 is a schematic diagram illustrating an included angle between a ridged line of the reflecting device and a plane where a light source plate is located in the lighting apparatus provided by the first example of the present disclosure;

FIG. 7 is an optical path diagram of a single saw-tooth structure in a vertical direction according to the first example of the present disclosure, by way of example;

FIG. 8 is an optical path diagram of a single saw-tooth structure in a horizontal direction according to the first example of the present disclosure, by way of example;

FIG. 9 is a perspective view of a lighting apparatus provided by a second example of the present disclosure;

FIG. 10 is an exploded view of the lighting apparatus in FIG. 9;

FIG. 11 is an exploded view of the lighting apparatus in FIG. 9 from another viewing angle;

FIG. 12 is a sectional view taken along B-B line in FIG. 9;

FIG. 13 is a perspective view of a lighting apparatus provided by a third example of the present disclosure;

FIG. 14 is an exploded view of the lighting apparatus in FIG. 13;

FIG. 15 is an exploded view of the lighting apparatus in FIG. 13 from another viewing angle;

FIG. 16 is a sectional view taken along C-C line in FIG. 13;

FIG. 17 is a perspective view of a lighting apparatus provided by a fourth example of the present disclosure; and

FIG. 18 is an exploded view of the lighting apparatus in FIG. 17.

### DETAILED DESCRIPTION

In order to make objects, technical solutions and advantages of the present disclosure more apparent, the technical solutions of the examples will be described in a clear and complete way in connection with specific examples and corresponding drawings of the present disclosure. Apparently, the described examples are just a part but not all of the examples of the present disclosure. Based on the examples in the present disclosure, those ordinary skilled in the art can obtain all other example(s), without any inventive work, which all should be within the scope of the present disclosure.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

### The First Example

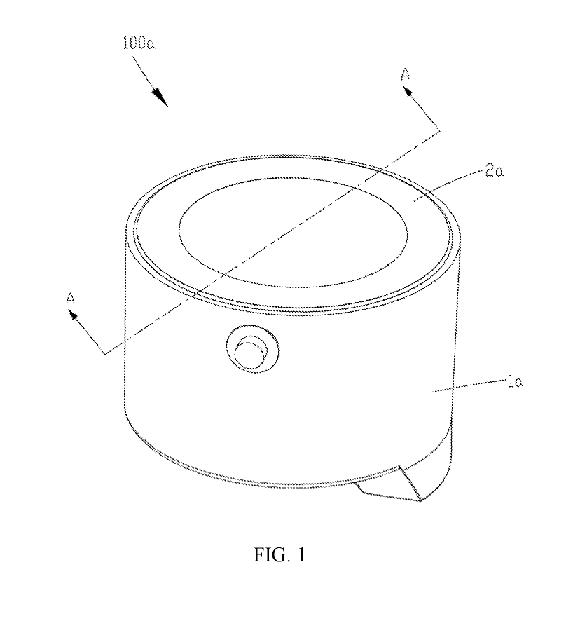

As illustrated in FIGS. 1-4, an example of the present disclosure provides a lighting apparatus 100a, which is a spotlight lamp. Particularly, the lighting apparatus 100a includes a lamp body 1a, an optical element 2a connected with the lamp body 1a, a heat sink 6a received in the lamp body 1a, a driving power source assembly 4a received in the heat sink 6a, a light source assembly 3a received in the heat sink 6a, and a reflecting device 5a configured to provide a secondary light distribution for the light source assembly 3a and received in the heat sink 6a. The light source assembly 3a is disposed at an end of the reflecting device 5a. It should be explained that, the reflecting device 5a is in an annular shape and is transparent; a part of light emitted from the light source assembly 3a directly exits through the optical element 2a, and another part of the light is reflected by the reflecting device 5a and then exits through the optical element 2a.

Hereinafter, various components and connecting relationships among components in the lighting apparatus 100a provided by the example of the present disclosure will be described in more details.

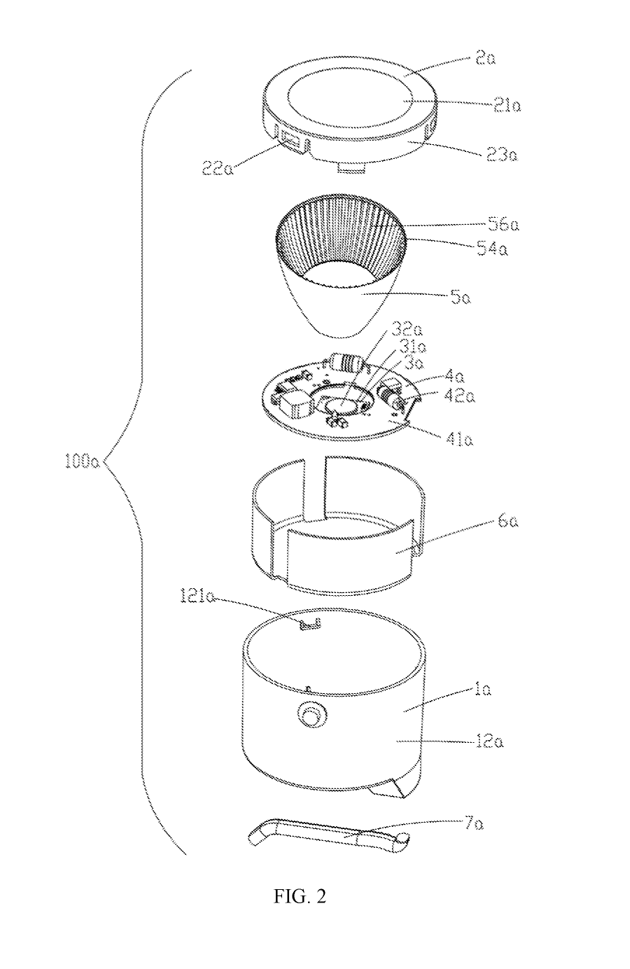

As illustrated in FIG. 2, the lamp body 1a is in a cylindrical shape; the lamp body 1 is connected with the optical element 2a to form a receiving chamber 10a; the light source assembly 3a, the driving power source assembly 4a, the reflecting device 5a and the heat sink 6a are all received in the receiving chamber 10a. Particularly, the lamp body 1a includes a bottom wall 11a and a side wall 12a, an internal surface of the side wall 12a is provided with a plurality of protrusions 121a which may also be grooves in other alternative examples. The lamp body 1a may be made of a thermal-conductive metallic material such as Al, and may also be integrally formed from thermal-conductive plastic or plastic material overlaid with Al. As a result, the lamp body 1a has high thermal conductivity. When the light source assembly 3a located inside the receiving chamber 10a generates heat, the heat may be quickly dissipated through the lamp body 1a, so as to prevent from an excessively high temperature inside the receiving chamber 10a which may affect a service quality and a service life of the light source assembly 3a.

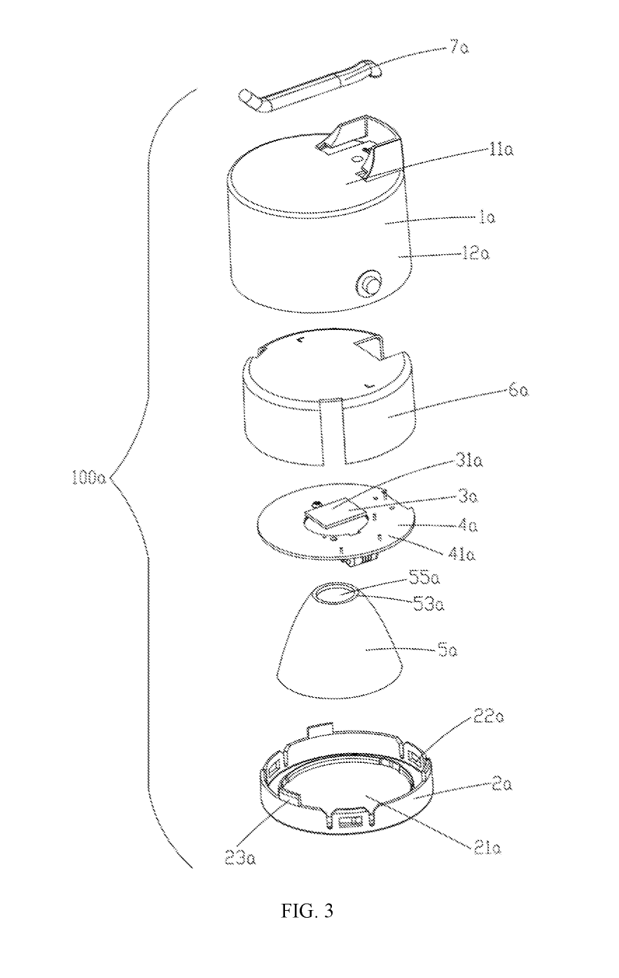

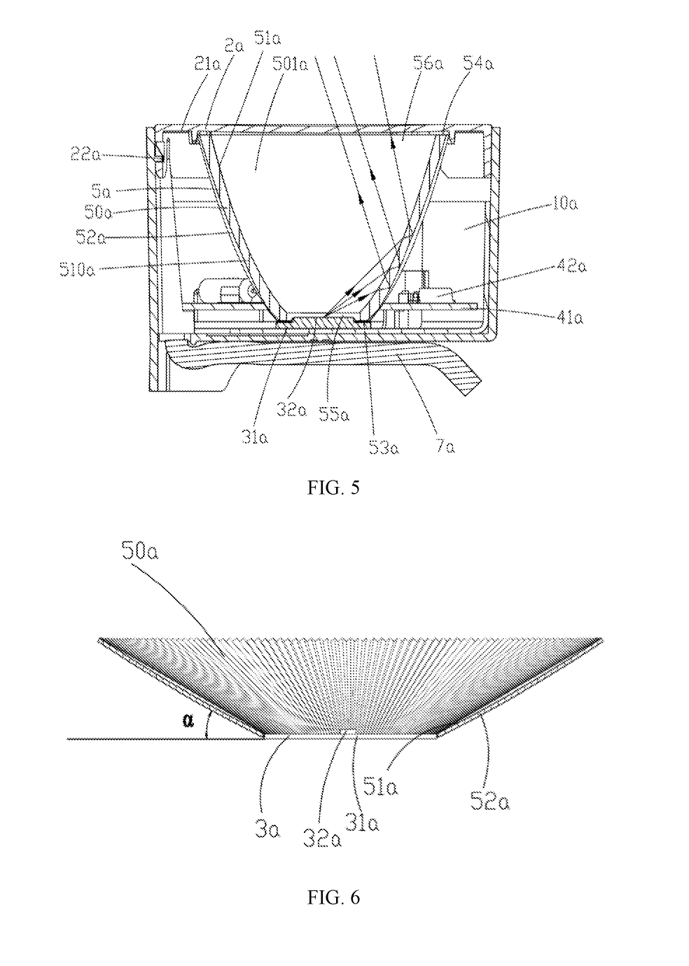

As illustrated in FIG. 2, FIG. 3 and FIG. 5, the optical element 2a is in a circular shape, and is connected with the lamp body 1a in a snap-fit manner. In the present example, the optical element 2a plays a role of brightness balance. Particularly, the optical element 2a includes a circular-shaped top wall 21a, and a plurality of clamping structures 22a and abutting structures 23a which are extending downwards from the top wall 21a. The protrusion 121a is received in the clamping structure 22a, so as to achieve a connection between the lamp body 1a and the optical element 2a in a snap-fit manner. The abutting structure 23a is configured to press against the heat sink 6a inside the lamp body 1a.

The heat sink 6a is in a housing shape, the light source assembly 3a and the driving power source assembly 4a both are received in the heat sink 6a. In the present example, the heat sink 6a is disposed between the lamp body 1a and the optical element 2a in a manner of abutting against the lamp body 1a and the optical element 2a. Particularly, a lower surface of the heat sink 6a is attached onto the bottom wall 11a of the lamp body 1a, and an upper end face of the heat sink 6a is abutted against an end face of the abutting structure 23a of the optical element 2a. The heat sink 6a may be made of a thermal-conductive metallic material such as Al, and may also be integrally formed from a plastic material overlaid with Al.

As illustrated in FIG. 2 and FIG. 3, the light source assembly 3a includes a light source plate 31a and a light-emitting unit 32a located on the light source plate 31a. Particularly, the light-emitting unit 32a is disposed at the middle part of the light source plate 31a, that is, disposed at the middle of an opened side of the reflecting device 5a. In the present example, the light-emitting unit 32a is a light-emitting diode (LED) light source. The number of the light-emitting unit 32a may be one or plural. When a plurality of light-emitting units 32 is provided, it needs to intensely dispose these light-emitting units 32 at a central area of a light inlet 55a of the reflecting device 5a. In the present example, the light source plate 31a is fixed inside the heat sink 6a, and is positioned through a positioning surface (not labeled) disposed on the lamp body 1a.

The driving power source assembly 4a includes an annular-shaped power source plate 41a and a LED driving power source 42a located at one side of the light source plate 41a. In the present example, the power source plate 41a is located at an external side of the light source plate 31a and is located above the light source plate 31a. The LED driving power source 42a includes a plurality of components, including but not limited to a LED driving controller chip, a rectification chip, a resistor, a capacitor, a fuse wire, a coil and the like. The lighting apparatus 100a of the present example further includes a power source line 7a, the power source line 7a extends into the lamp body 1a and is welded to the power source plate 41a; the power source plate 41a transmits an external power to the LED driving power source 42a, and the LED driving power source 42a further drives the LED light source 32a to emit light.

In other alternative examples, the LED light source 32a and the LED driving power source 42a may also be integrated onto a same substrate (not illustrated) by using Through Hole Technology (THT) or Surface Mount Technology (SMT). The LED driving power source 42a may be partly bonded onto one side of the substrate provided with the LED light source 32a, and the other side of the substrate is provided with a plug-in type driving power source component to reduce the cost; the LED driving power source 42a may also be completely bonded onto the side of the substrate provided with the LED light source 32a; or the LED driving power source 42a is completely formed as a plug-in part on the other side (not provided with the LED light source 32a) of the substrate; or the LED driving power source 42a is partly bonded onto the other side and partly formed as a plug-in part on the other side.

As illustrated in FIGS. 2-5, the reflecting device 5a uses a lens as the reflecting wall 50a, which is in an annular shape and has uniform thickness. The reflecting wall 50a encloses and delimits an optical space 501a. Such structure is similar to a reflection cup but uses a transparent material, which makes the structure visible from outside and is easy to replace the reflection cup. Particularly, the reflecting wall 50a has an internal surface 51a, an external surface 52a, a first end face 53a and a second end face 54a; the light inlet 55a of the reflecting device 5a is located at the first end face 53a; the light outlet 56a is located at the second end face 54a, that is, the reflecting wall 50a is located between the light inlet 55a and the light outlet 56a. The light inlet 55a and the light outlet 56a are communicated with the optical space 501a; the light source plate 31a closes the light inlet 55a; and a diameter of the light inlet 55a is smaller than a diameter of the light outlet 56a. The internal surface 51a is a light incident surface of the reflecting device 5a, and is also a light emergent surface of the reflecting device 5a. Particularly, the internal surface 51a is constituted by a circle of saw-tooth structures arranged continuously. Each of the saw-tooth structures includes a first refracting surface 511a and a second refracting surface 512a which are intersected with each other. The first refracting surface 511a and the second refracting surface 512a are perpendicular to each other and are intersected with each other to generate a ridged line which may be a straight line and may also be an arc line. Two ends of each of the saw-tooth structures 510a extend to the first end face 53a and the second end face 54a, respectively. The external surface 52a is a smooth wall surface, and is also a total reflection surface. In other examples, the included angle between the first refracting surface 511a and the second refracting surface 512a may not be 90°, that is, the included angle may be smaller than or greater than 90°; and a best luminous efficiency of the reflecting device 5a may be obtained when the included angle of the saw-tooth structure 510a is 90°, in which the emergent light may be subjected to a total reflection along a direction of the incident light. An included angle of the saw-tooth structure 510a that is smaller than or greater than 90° may change an emergent angle of the original light which may be obtained by reflection, and hence degrade the luminous efficiency.

The reflecting device 5a is integrally formed from transparent plastic or glass material. The plastic material may be selected as polymethyl methacrylate (PMMA), polycarbonate (PC) and the like. A smallest thickness of the reflecting device 5a may be made as 2 mm, thus it can save the cost of materials and the difficulty of formation if the reflecting device 5a has a greater structural size.

An incident angle of light with respect to a reflecting surface can be great enough so as to realize a total reflection in a lens; otherwise the light would be transmitted through the lens. Such incident angle would be changed with the marital of the lens. In order to allow all the light that is incident into the reflecting device 5a to be subjected to a total reflection at the external surface 52a, it's necessary to design the angle of the light with respect to the external surface 52a. The incident angle in FIG. 8 is not enough for a total reflection, and the total reflection is achieved herein because there is also another angle in a vertical component.

As illustrated in FIG. 5 and FIG. 6, an incident angle obtained by superimposing a horizontal component with the vertical component is great enough. For this end, the incident angle in the vertical direction has to be greater than a certain angle to achieve total reflection. The incident angle in the vertical direction is greater than a certain angle, that is, an included angle α between a ridged line generated by the first refracting surface 511a intersecting with the second refracting surface 512a and a plane where the light source plate 31a is located needs to be smaller than a certain angle A. If the light is incident at the first refracting surface 511a or the second refracting surface 512a, a refraction would be taken place, so that the incident angle of the light at the external surface would be increased; whereas, if the light is incident at the position of the ridged line, it would be most difficult to achieve a total reflection because there is barely an angle in the horizontal direction. As a result, when considering a design in which the entire reflecting wall 50a is a total reflection surface, the value of A is always calculated according to an optical path at the position of the ridged line. Such included angle α is related to the refractivity of the reflecting wall 50a. In the present example, if a PC material is selected, A is 38°; if a material having higher refractivity is selected, A may be 40°; and if PMMA is selected, A is 30°. For the reflecting device 5a in the present example, when the ridged line is an arc line, an included angle α between a tangent line of every point on the ridged line and the plane where the light source plate is located should satisfy the above-mentioned restricted condition, that is, the value of a is smaller than A. As a result, when the included angle α is smaller than the angle A (A is an angle corresponding to different materials as mentioned above) corresponding to different materials, the reflecting device 5A satisfies the condition for total reflection. In other examples where a total reflection of the lens is not necessary, it may not satisfy the condition of the included angle α being smaller than A, that is, any included angle in the range from 0° to 90° may be adopted. In this way, a transflective effect may be obtained on the external surface 52a.

Additionally, it needs to explain that, during mold designing or molding, on account of matching precision, a rounded corner would be formed at an intersecting line between the first refracting surface 511a and the second refracting surface 512a of the reflecting device 5a, and the light incident onto the rounded corner would be refracted and exit as stray light. The greater the rounded corner is, the smaller the central light intensity and the more the stray light will be. However, the rounded corner formed by the matching precision has little influence to the entire luminous efficiency and beam angle of the reflecting device 5a. Therefore, it's still believed that the reflecting device 5a is a total reflection lens.

Hereinafter, the optical path of the light emitted from the light-emitting unit 32a after the light entering the internal surface 51a of the reflecting device 5a will be described in more details.

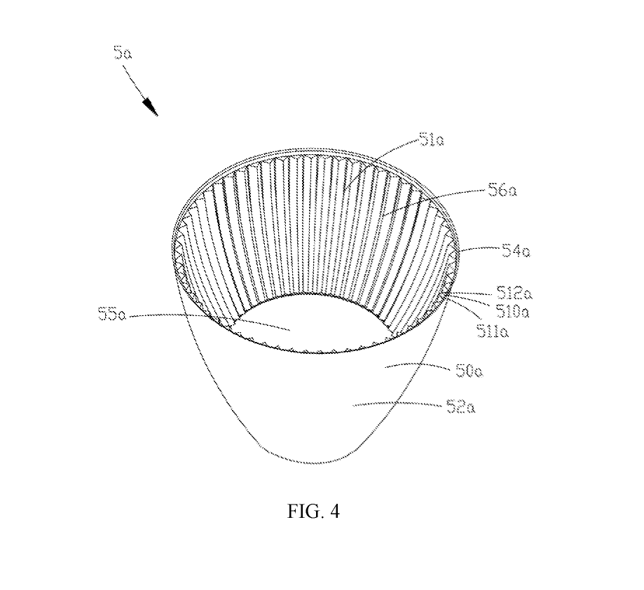

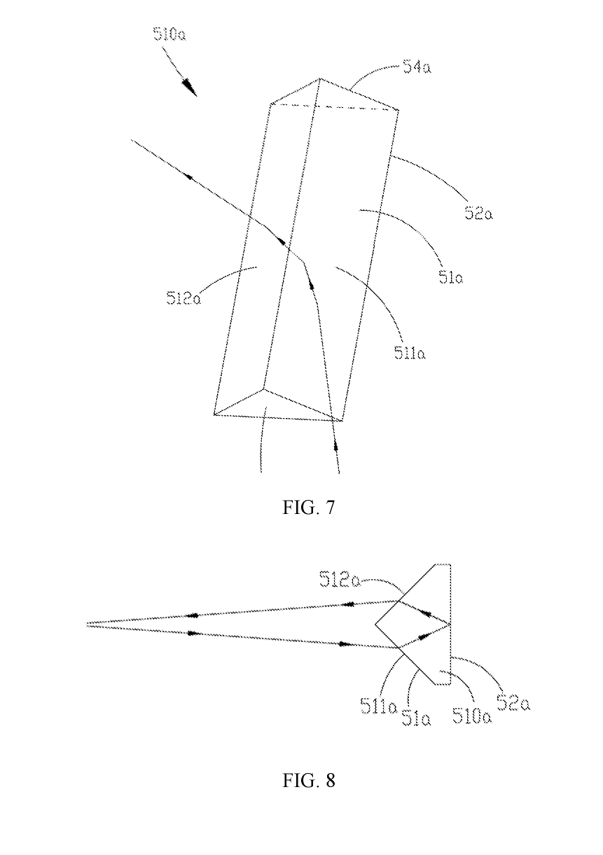

As it can be seen from FIGS. 4-8, the light emitted from the light-emitting unit 32a enters the light inlet 55a; a part of the light is directly emitted to the optical element 2a through the light outlet 56a, and then exits through the optical element 2a; and another part of the light is reflected by the reflecting device 5a, then is emitted through the light outlet 56a, and finally exits through the optical element 5a. The particular optical path is described as below.

The light is incident onto the internal surface 51a of the reflecting wall 50a, then is refracted to the external surface 52a by the first refracting surface 511a of the saw-tooth structure 510a onto the internal surface 51a, then is totally reflected to the internal surface 51a by the external surface 52a, then is refracted into the optical space 501a by the internal surface 51a, then is emitted to the outside through the light outlet 56a, and finally exits through the optical element 2a. FIG. 8 illustrates an optical path of the light after entering the saw-tooth structure 510a, in which the light is totally reflected to the second refracting surface 512a of the internal surface 51a by the external surface 52a, and then exits. Other light (not illustrated) emitted from the light-emitting unit 32a, partly is reflected to the first refracting surface 511a of the internal surface 51a by the external surface 52a and then exits, and partly is reflected to the ridged line at the intersection between the first refracting surface 511a and the second refracting surface 512a by the external surface 52a, and then exits. As it can be seen in connection with FIG. 6, all of the light incident onto the reflecting wall 50a can be subjected to a total reflection and then exits through the internal surface 51a as long as the included angle α between the ridged line and the plane where the light source plate 31a is located satisfies the angle range corresponding to different materials.

### The Second Example

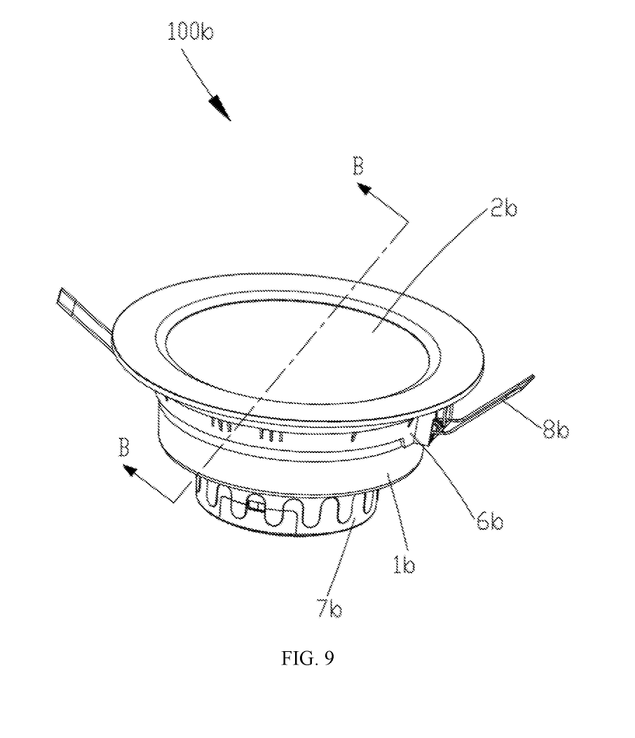

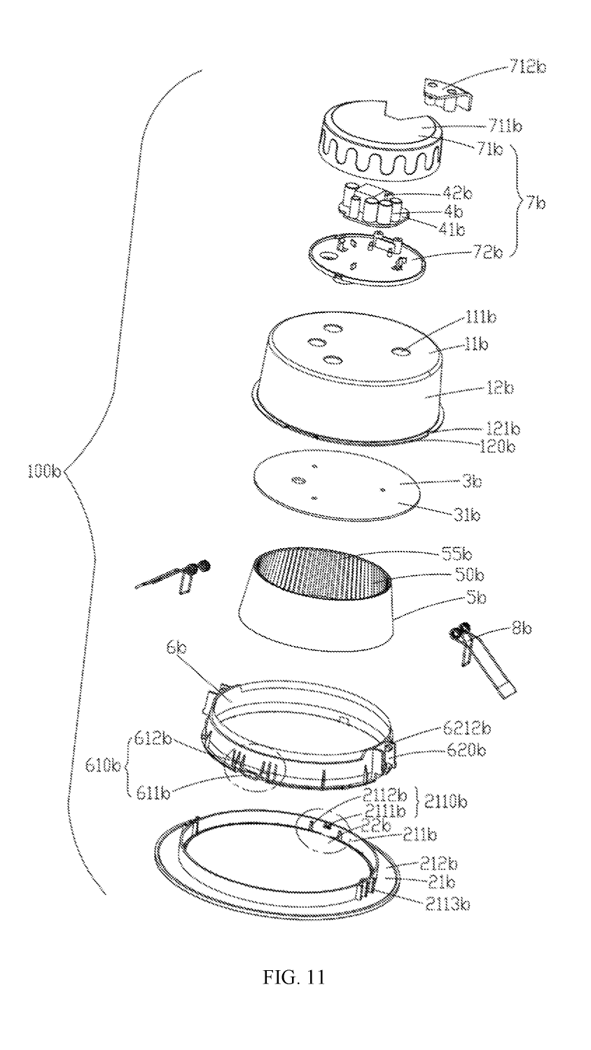

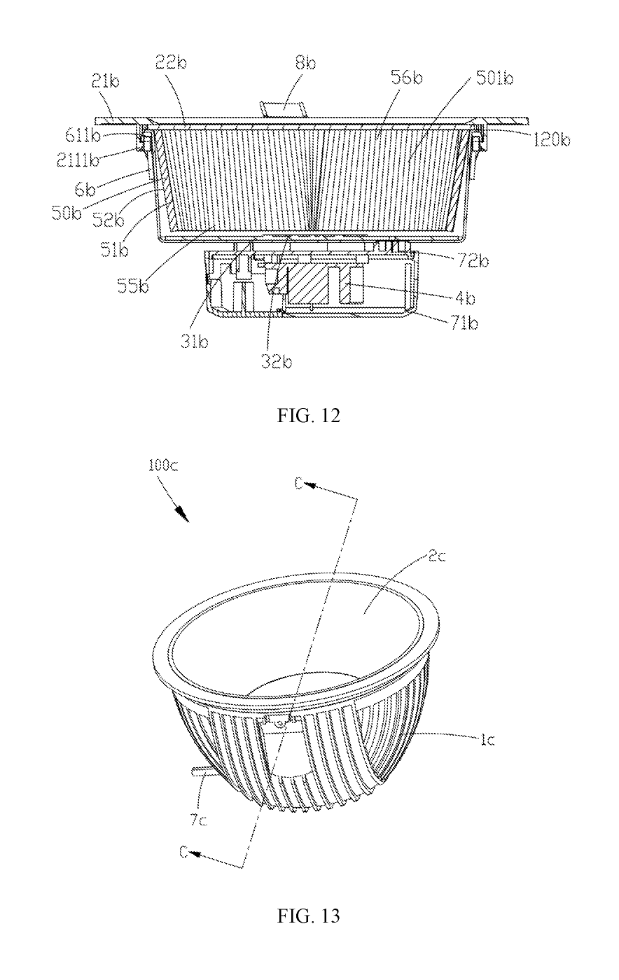

As illustrated in FIGS. 9-12, an example of the present disclosure provides a lighting apparatus 100b which is a downlight lamp. Particularly, the lighting apparatus 100b includes a lamp body 1b, an optical element 2b connected at a frond end of the lamp body 1b, a connecting part 6b sleeved at a periphery of the lamp body 1b, two clamp springs 8b connected onto the connecting part 6b, a driving power source box 7b connected at a rear end of the lamp body 1b, a light source assembly 3b received in the lamp body 1b, a reflecting device 5b received in the lamp body 1b and configured to provide a secondary light distribution for the light source assembly 3b, and a driving power source assembly 4b received in the driving power source box 7b and electrically connected to the light source assembly 3b. The light source assembly 3b is disposed at an end of the reflecting device 5b. It should be explained that, the reflecting device 5b is in an annular shape and is transparent; the light emitted from the light source assembly 3b, partly exits through the optical element 2b directly, and partly is reflected by the reflecting device 5b and then exits through the optical element 2b.

Hereinafter, various components and connecting relationships among components in the lighting apparatus 100b provided by the example of the present disclosure will be described in more details.

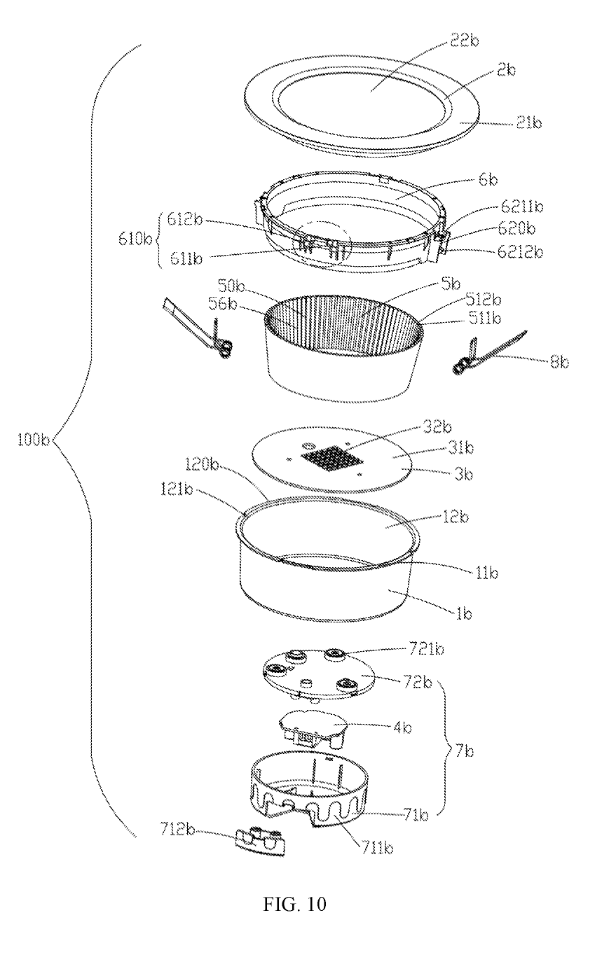

As illustrated in FIGS. 10-12, the lamp body 1b is in a cylindrical shape, including a bottom wall 11b and a side wall 12b; the bottom wall 11b is provided with a plurality of first through holes 111b; an annular-shaped connecting surface 120b extends from an upper end of the side wall 12b, and is provided with a plurality of notches 121b. In the present example, the notch 121b has a semi-circular shape. The lamp body 1b may be made of a thermal-conductive metallic material such as Al, and may also be made of thermal-conductive plastic. As a result, the lamp body 1b has high thermal conductivity. When the light source assembly 3b located inside the lamp body 1b generates heat, the heat may be quickly dissipated through the lamp body 1b, so as to prevent from an excessively high temperature inside the lamp body 1b which may affect a service quality and a service life of the light source assembly 3b.

As illustrated in FIGS. 10-12, the optical element 2b plays a role of brightness balance. Particularly, the optical element 2b includes a surface ring 21b and a brightness balance plate 22b located at an inner side of the surface ring 21b. In the present example, the brightness balance plate 22b is disposed between the surface ring 21b and the reflecting device 5b in a manner of abutting against the surface ring 21b and the reflecting device 5b. In other alternative examples, the brightness balance plate 22b may be fixed inside the lighting apparatus 100b by using other fixing manners. The surface ring 21b may be made of a metallic material or plastic, including a main body 211b in a vertical, circular ring shape, and an annular surface 212b which is integrally connected with the main body 211b and is in a horizontal, circular ring shape. Particularly, an internal surface of the main body 211b is provided with a plurality of first connecting structures 2110b; the first connecting structure 2110b includes a bump 2111b and a fastening strip 2112b located at both sides of the bump 2111b; the fastening strip 2112b extends axially along the main body 211b. The main body 211b is provided with a plurality of positioning posts 2113b; the positioning post 2113b extends along an axial direction, and an end face of the positioning post 2113b extends beyond an end face of the main body 211b.

The connecting part 6b is in a circular ring shape, and an external side surface of the connecting part 6b is provided with a plurality of second connecting structures 610b and third connecting structures 620b. Particularly, the second connecting structure 610b includes a clamping block 611b and a positioning groove 612b located at both sides of the clamping block 611b; the positioning groove 612b extends axially along the connecting part 6b. The third connecting structure 620b includes a clamp spring mounting part 6212b and a connecting plate (not denoted) provided with a second through hole 6211b. In the present example, the first connecting structure 2110b is connected with the second connecting structure 610b, so as to realize a connection between the connecting part 6b and the surface ring 21b. Particularly, the fastening strip 2112b is received in the positioning groove 612b to realize a positioning between the connecting part 6b and the surface ring 21b; the bump 2111b is clamped at a lower surface of the clamping block 611b to be connected thereto, so as to realize a connection between the connecting part 6b and the surface ring 21b. At the same time, the lighting apparatus 100b of the present example further includes a screw (not illustrated), the screw passes through the second through hole 6211b to be received inside the positioning post 2113b, so as to further enhance the connection between the connecting part 6b and the surface ring 21b. Moreover, an upper face and a lower face of the connecting surface 120b are abutted against the surface ring 21b and the connecting part 6b, respectively; the positioning post 2113b is posited at an external side of the notch 121b so as to fix the lamp body 1b between the surface ring 21b and the connecting part 6b. In other alternative examples, the connecting part 6b may be omitted, the optical element 2b may be directly connected with the lamp body 16, and the clamp spring 8b is connected onto the optical element 2b.

In the present example, the clamp spring 8b is made of a metallic material and is clamped inside the clamp spring mounting part 6212b.

As illustrated in FIGS. 10-12, the driving power source box 7b includes a lower cover 71b in a housing shape, and an upper cover 72b in a plate shape; the lower cover 71b and the upper cover 72b are connected with each other in a snap-fit manner. An external surface of the upper cover 72b is provided with a plurality of connecting posts 721b protruded therefrom, and the connecting post 721b passes through the first through hole 111b to be connected with the light source assembly 3b. The lower cover 71b includes a first cover body 711b and a second cover body 712b; the first cover body 711b and the upper cover 72b are connected with each other in a snap-fit manner. The second cover body 712b and the first cover body 711b may be assembled with each other in a detachable manner.

The driving power source assembly 4b is connected onto an internal surface of the upper cover 72b. Particularly, the driving power source assembly 4b includes an annular-shaped power source plate 41b and a LED driving power source 42b located at one side of the power source plate 41b. In the present example, the power source plate 41b and the upper cover 72b are connected with each other in a snap-fit manner. The LED driving power source 42b includes a plurality of components, including but not limited to a LED driving controller chip, a rectification chip, a resistor, a capacitor, a fuse wire, a coil and the like. The lighting apparatus 100b of the present example further includes a power source line (not illustrated); the power source line extends into the lower cover 71b and is welded to the power source plate 41b; the power source plate 41b transmits an external power to the LED driving power source 42b, and the LED driving power source 42b further drives the light source assembly 3b to emit light. In the present example, the second cover body 712b and the power source plate 41b are fixedly connected with each other through a screw (not illustrated) so as to fixedly connect the lower cover 71b with the power source plate 41b.

In the present example, the second cover body 712b is inserted into the first cover body 711b to be connected thereto, so that the first cover body 711b and the second cover body 712b cannot be movable with each other in the up and down direction. Further, the second cover body 712b and the power source plate 41b are detachably fixed with each other through a screw (not illustrated).

As illustrated in FIGS. 10-12, the light source assembly 3b includes a light source plate 31b and a light-emitting unit 32b located on the light source plate 31b. Particularly, the light-emitting unit 32b is disposed at the middle part of the light source plate 31b, that is, disposed at the middle part of an opened side of the reflecting device 5b. In the present example, the light-emitting unit 32b is a LED light source, and a plurality of light-emitting units 32b is provided; these light-emitting units 32b are arranged on the light source plate 31b in an array. In other alternative examples, the driving power source assembly 4b may also be directly integrated onto the light source plate 31b; the driving power source box 7b may be reserved but only matched with the lamp body 1b in its appearance, an interior of the driving power source box 7b may be empty.

As illustrated in FIGS. 10-14, the reflecting device 5b uses a lens as the reflecting wall 50b, which is in an annular shape and has uniform thickness. The reflecting wall 50b encloses and delimits an optical space 501b. A structure and an optical path of the reflecting device 5b are similar to that of the reflecting device 5a in the foregoing example. Particularly, the reflecting device 5b includes an internal surface 51b, an external surface 52b, a light inlet 55b and a light outlet 56b; the internal surface 51b includes a saw-tooth structure 510b; the light inlet 55b and the light outlet 56b are communicated with the optical space 501b; the light source plate 31b closes the light inlet 55b. The difference between the reflecting device 5b and the reflecting device 5a lies in that the diameters of the light inlet and the light outlet of the two reflecting devices are different.

Moreover, in order to achieve the total reflection at the reflecting wall 50b, it also needs the included angle α formed between the ridged line generated by the first refracting surface 511b intersecting with the second refracting surface 512b and the plane where the light source 31b is located to be smaller than a certain angle A. In the present example, if a PC material is selected, A is 38°; if a material having higher refractivity is selected, A may be 40°; and if PMMA is selected, A is 30°.

### The Third Example

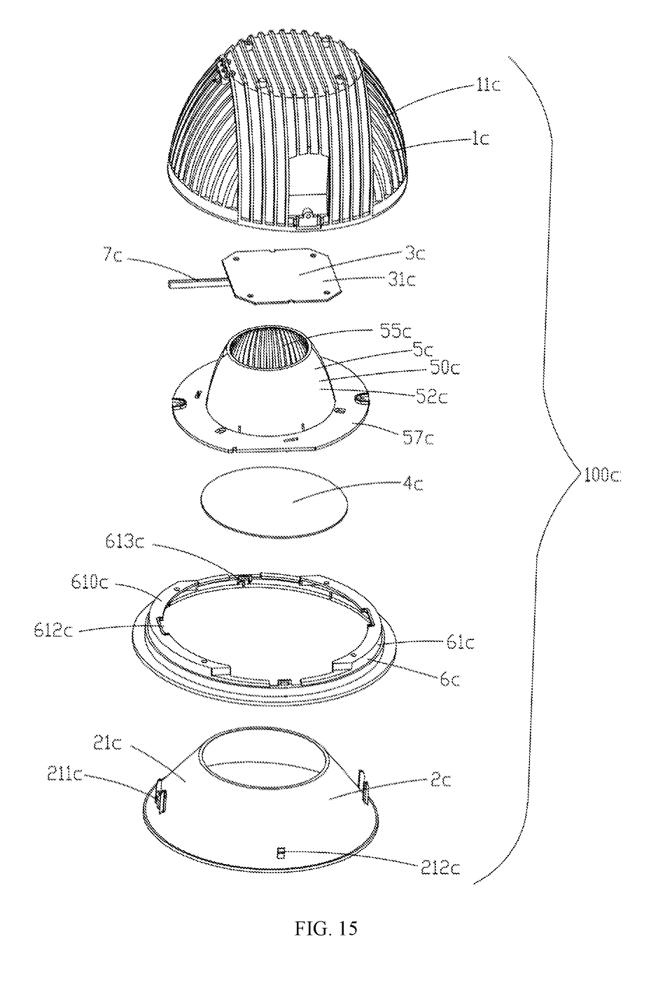

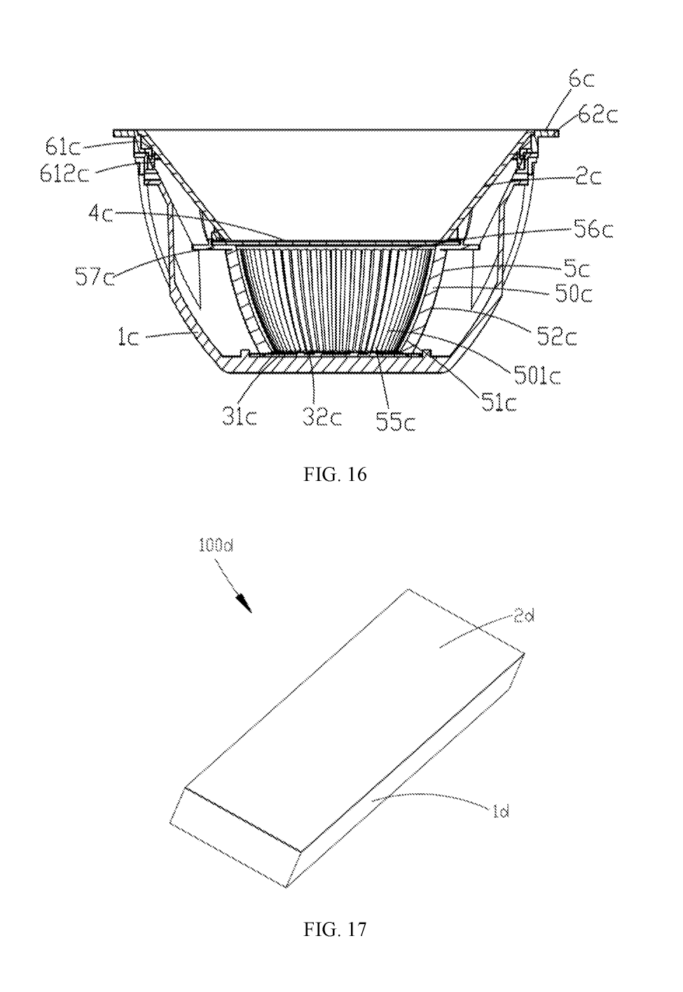

As illustrated in FIGS. 13-16, an example of the present disclosure provides a lighting apparatus 100c, including a lamp body 1c, an optical element 2c connected at a front end of the lamp body 1c, a surface ring 6c configured to connect the lamp body 1c with the optical element 2c, a light source assembly 3c received in the lamp body 1c, a reflecting device 5c received in the lamp body 1c and configured to provide a secondary light distribution for the light source assembly 3c, and a brightness balance plate 4c covering a light outlet of the reflecting device 5c. The light source assembly 3c is disposed at one end of the reflecting device 5c. It should be explained that, the reflecting device 5c is in an annular shape and is transparent. A part of the light emitted from the light source assembly 3c directly exits through the brightness balance plate 4c; and another part of the light is reflected by the reflecting device 5c, then subjected to a brightness balance by the brightness balance plate 4c, and finally exists through the optical element 2c. The lighting apparatus 100c of the present example is a two-staged reflective downlight lamp, in which the reflecting device 5c is a first staged reflector and the optical element 2c is a second staged reflector in a form of reflex housing. The lighting apparatus 100c has better luminous efficiency without stray light having great angle.

Hereinafter, various components and connecting relationships among components in the lighting apparatus 100c provided by the example of the present disclosure will be described in more details.

As illustrated in FIGS. 13-16, the lamp body 1c is in a housing shape, including a bottom wall 11c and a side wall 12c; an internal surface of the side wall 12c is provided with a plurality of first receiving posts 121c and second receiving posts 122c. The lamp body 1c may be made of a thermal-conductive metallic material such as Al, and may also be made of thermal-conductive plastic; an external surface of the side wall 12c of the lamp body 1c is provided with a radiator fin. As a result, the lamp body 1c has high thermal conductivity. When the light source assembly 3c located inside the lamp body 1c generates heat, the heat may be quickly dissipated through the lamp body 1c, so as to prevent from an excessively high temperature inside the lamp body 1c which may affect a service quality and a service life of the light source assembly 3c.

As illustrated in FIGS. 13-16, the light source assembly 3b includes a light source plate 31c and a light-emitting unit 32c located on the light source plate 31c. Particularly, the light source plate 31c is fixed on the bottom wall 11c of the lamp body 1c through a screw (not illustrated); the light-emitting unit 32c is disposed at the middle part of the light source plate 31c, that is, disposed at the middle part of an opened side of the reflecting device 5c. In the present example, the light-emitting unit 32c is a LED light source, and a plurality of light-emitting units 32c is provided; these light-emitting units 32c are arranged on the light source plate 31c in a circular array. The driving power source assembly (not illustrated) is disposed outside the lamp body 1c, and a power supply line 7c connected to the driving power source assembly is connected to the light source plate 31c so as to further drive the light-emitting unit 32c to emit light.

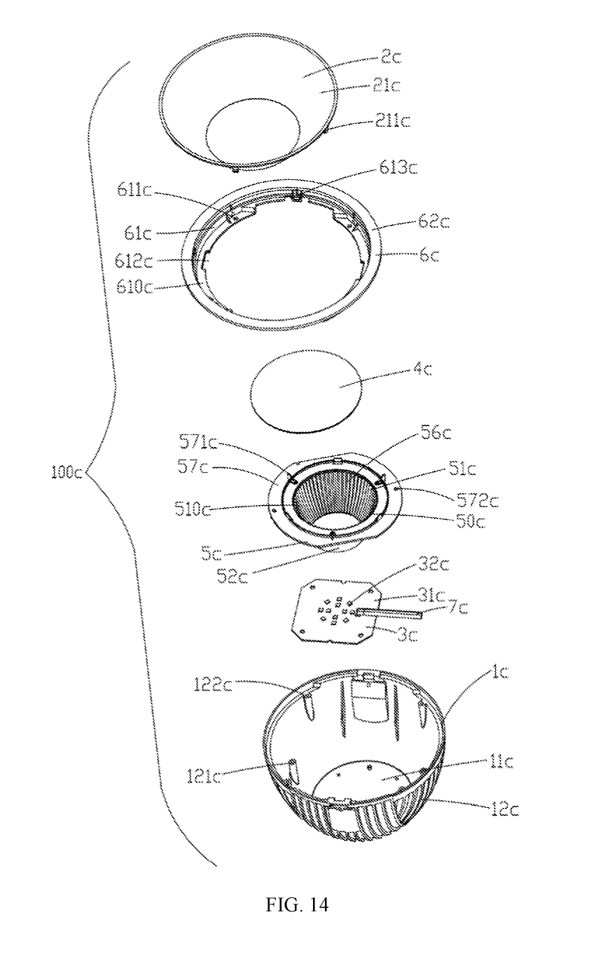

As illustrated in FIGS. 14-16, the reflecting device 5c uses a lens as the reflecting wall 50c, which is in an annular shape and has uniform thickness. The reflecting wall 50c encloses and delimits an optical space 501c. A structure and an optical path of the reflecting device 5c are similar to that of the reflecting device 5a in the first example. Particularly, the reflecting device 5c includes an internal surface 51c, an external surface 52c, a light inlet 55c and a light outlet 56c; the internal surface 51c includes a saw-tooth structure 510c; the light inlet 55c and the light outlet 56c are communicated with the optical space 501c; the light source plate 31c closes the light inlet 55c. The difference between the reflecting device 5c and the reflecting device 5a lies in that an end of the reflecting device 5c provided with the light outlet 56c is integrally connected with a horizontal, annular surface 57c, and also lies in that the diameters of the light inlet and light outlet of the two reflecting devices are different. Particularly, the horizontal, annular surface 57c is provided with a plurality of clamping structures 571c protruded therefrom, and the clamping structure is configured to fix the brightness balance plate 4c; the annular surface 57c is further provided with a plurality of third through holes 572c, the lighting apparatus 100c of the present example further includes a screw (not illustrated), and a connection between the reflecting device 5c and the lamp body 1c is achieved by passing the screw through the third through hole 572c to be received in the first receiving post 121c.

In the present example, the brightness balance plate 4c is snap-fitted onto the reflecting device 5c. In other alternative examples, the brightness balance plate 4c may be fixed inside the lighting apparatus 100c by using other fixing manners.

As illustrated in FIGS. 14-16, the surface ring 6c may be made of a metallic material or plastic, including a main body 61c in a vertical, circular ring shape, and an annular surface 62c which is integrally connected with the main body 61c and is in a horizontal, circular ring shape. Particularly, the main body 61c extends inwardly to form a connecting plate 610c, and the connecting plate 610c is provided with a plurality of fourth through holes 611c penetrating the connecting plate 610c in the up and down direction. The lighting apparatus 100c of the present example further includes a screw (not illustrated), and a connection between the surface ring 6c and the lamp body 1c is achieved by passing the screw through the fourth through hole 611c to be received in the second receiving post 122c. The connecting plate 610c is further provided with a first clamping structure 612c and a second clamping structure 613c; the first clamping structure 612c is a concaved groove, while the second clamping structure 613c includes a clamping groove.

The optical element 2c is a second staged reflector in a housing shape, which is located at an inner side of the surface ring 6c and is connected with the surface ring 6c. The optical element 2c may play a role of light-shielding angle to remove the influence of stray light having great angle. The optical element 2c includes a side wall 21c which is electroplated or sprayed with paint, and the side wall 21c only plays a reflecting function. An external surface of the side wall 21c is provided with a plurality of first protrusion structures 211c and second protrusion structures 212c; the first protrusion structure 211c is connected with the first clamping structure 612c in a snap-fit manner, and the second protrusion structure 212c is connected with the second clamping structure 613c in a snap-fit manner so as to realize a connection between the optical element 2c and the surface ring 6c.

### The Fourth Example

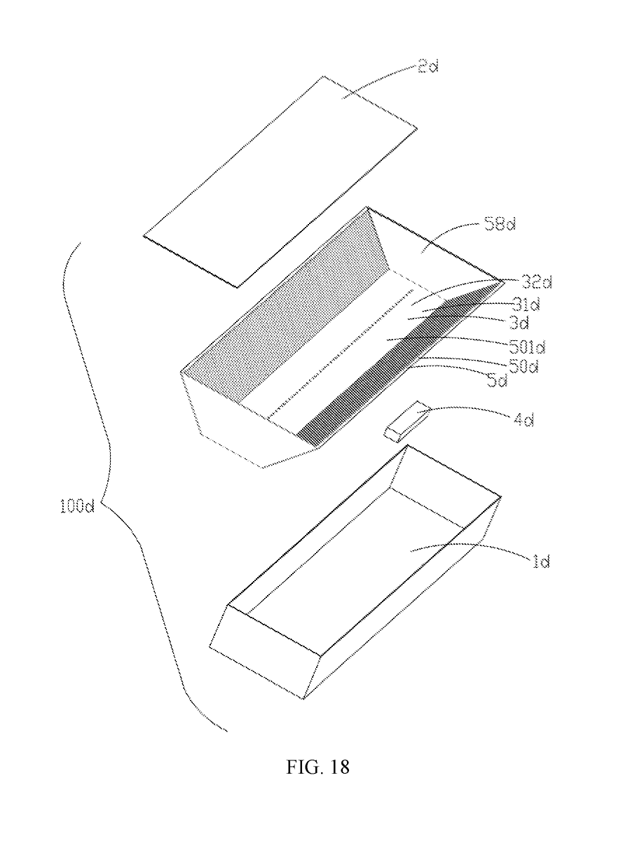

As illustrated in FIGS. 17-18, the fourth example of the present disclosure provides a lighting apparatus 100d, the lighting apparatus 100d is in a rectangular shape and includes: a lamp body 1d, an optical element 2d connected with the lamp body 1d, a driving power source assembly 4d received in the lamp body 1d, a light source assembly 3d received in the lamp body 1d, and a reflecting device 5d received in the lamp body 1d and configured to provide a secondary light distribution for the light source assembly 3d. The light source assembly 3d is disposed at one end of the reflecting device 5d. It should be explained that, the light emitted from the light source assembly 3d partly exits through the optical element 2d directly, and partly is reflected by the reflecting device 5d and then exits through the optical element 2d. The lighting apparatus 100d may be applied in lighting fixtures such as ceiling lamp, fresh lamp and outdoor lamp.

In the present example, the reflecting device 5d uses two lenses disposed opposite to each other as the reflecting walls 50d, and a connecting plate 58d is disposed between the two reflecting walls 50d, so as to constitute a complete, reflecting device. The connecting plate 58d, together with the reflecting walls 50d, may enclose and delimit an optical space 501d, as illustrated in FIG. 18; the connecting plate 58d may also be disposed at the bottom, that is, the position of the light source assembly 3d in the drawings, so that the connecting plate 58d and the reflecting walls 50d may form a structure with a closed bottom and an opened top. In some other examples, the connecting plate may not be adopted, and a square-shaped or a polygonal-shaped reflecting device may be formed by using four or more reflecting walls 50d. It should be explained that, a part of the light emitted from the light-emitting unit 32d is refracted, reflected and then refracted again by the reflecting wall 50d, then is directly emitted through the internal surface 51d of the reflecting wall 50d, and then exits through the light outlet; and another part of the light is reflected by the connecting plate 58d and is emitted through the internal surface (not labeled) of the connecting plate 58d, and then exits through the light outlet.

A structure and an optical path of the reflecting wall 50d are similar to that of the reflecting wall 50a of the reflecting device 5a in the first example, with the only difference that the reflecting wall 50d is in a plate shape while the reflecting wall 50a is in an annular shape. The ridged line of the reflecting wall 50d may be a straight line, and may also be an arc line.

The connecting plate 58d is also in a flat plate shape. The connecting plate 58d has two sides attached onto the side surface of the reflecting wall 50d, and has upper and lower end faces flush with upper and lower end faces of the reflecting wall 50d, respectively, so as to enclose the light-emitting unit 32d in the optical space 501d constituted by the reflecting wall 50d and the connecting plate 58d. An internal surface of the connecting plate 58d is a total reflection surface. In order to form the total reflection surface, the connecting plate 58d may be made of a material having a total reflection function such as plastic and metal; the total reflection surface may also be achieved by a surface treatment such as surface finishing process and plating process.

To sum up, in the lighting apparatus provided by the examples of the present disclosure, a lens is used as a reflecting device, an external surface of the reflecting device includes a plurality of saw-tooth structures arranged continuously, an internal surface of the reflecting device is used as a light incident surface and a light emergent surface at the same time, and the external surface includes a first reflecting surface and a second reflecting surface; with such design, all the light incident onto the internal surface can exit with an optical effect of total reflection, so as to improve the luminous efficiency without the need of an electroplating process.

The present disclosure provides a lighting apparatus with relatively higher luminous efficiency.

The present disclosure provides a lighting apparatus, including a lamp body, an optical element connected with the lamp body, a light source assembly received in the lamp body, a reflecting device received in the lamp body and configured to provide a secondary light distribution for the light source assembly, and a driving power source assembly received in the lamp body and electrically connected with the light source assembly; the reflecting device is provided with a light inlet, a light outlet and a reflecting wall located between the light inlet and the light outlet; the reflecting wall is transparent, and the reflecting wall includes an internal surface and an external surface;

the internal surface includes a plurality of saw-tooth structures arranged continuously; each of the saw-tooth structures includes a first refracting surface and a second refracting surface intersected with each other; two ends of each of the saw-tooth structures extend towards the light inlet and the light outlet, respectively,

the light source assembly is disposed at the light inlet of the reflecting device.

Further, the reflecting device is in an annular shape, and the reflecting device has uniform thickness.

Further, the first refracting surface and the second refracting surface are perpendicular to each other.

Further, the external surface of the reflecting wall is a smooth wall and is also a total reflection wall.

Further, a diameter of the light inlet is smaller than a diameter of the light outlet, and the two ends of the saw-tooth structure extend into at least one of the light inlet and the light outlet.

Further, the first refracting surface and the second refracting surface of the saw-tooth structure are intersected with each other to generate a ridged line, and the ridged line is a straight line or an arc line.

Further, an included angle between a tangent line of any point on the ridged line and a plane where the light inlet is located is smaller than A, wherein A is 40°.

Further, if a material of the reflecting wall is PC, A equals to 38°; and if the material of the reflecting wall is acrylic, A equals to 30°.

Further, two reflecting walls opposite to each other are provided, and each of the reflecting walls is in a flat plate shape.

Further, the reflecting device further includes a connecting plate disposed between the reflecting walls.

Further, the lighting apparatus further includes a heat sink received in the lamp body, and both of the light source assembly and the driving power source assembly are received in the heat sink.

Further, an upper end face and a lower end face of the heat sink, and/or, an upper surface and a lower surface of the heat sink, are disposed between the optical element and the lamp body in a manner of abutting against the optical element and the lamp body, respectively.

Further, the light source assembly and the driving power source assembly are disposed integrally or disposed separately.

Further, the light source assembly and the driving power source assembly are disposed separately; the driving power source assembly includes an annular-shaped power source plate and a driving power source located at one side of the power source plate; and the light source assembly is located at an inner side of the power source plate.

Further, the light source assembly includes a light source plate and a plurality of light-emitting units located on the light source plate.

Further, the lighting apparatus further includes a connecting part sleeved at a periphery of the lamp body, and the connecting part is connected with the lamp body and the optical element, respectively.

Further, the optical element includes a surface ring and a brightness balance plate located at an inner side of the surface ring.

Further, the surface ring includes a main body in a vertical, circular ring shape, and an annular surface which is connected integrally with the main body and is in a horizontal, circular ring shape; the main body is connected with the lamp body and the optical element, respectively.

Further, the lighting apparatus further includes two clamp springs which are connected at an external side of the connecting part.

Further, the lighting apparatus further includes a driving power source box connected with the lamp body, and the driving power source assembly is received in the driving power source box.

Further, the lighting apparatus includes a first staged reflector and a second staged reflector; the reflecting device is the first staged reflector, and the optical element is the second staged reflector which is in a form of reflex housing.

Further, the lighting apparatus further includes a brightness balance plate, the brightness balance plate covers the light outlet of the reflecting device, and the reflex housing is located above the brightness balance plate.

Further, the optical element includes a surface ring located at an external side of the reflex housing, and the surface ring is connected with the lamp body.

Further, an optical space is enclosed and delimited by the light inlet, the light outlet and the internal surface of the reflecting device; a part of light emitted from the light source assembly enters the reflecting wall upon being refracted by the internal surface, enters the optical space upon being reflected by the reflecting wall, and exits through the light outlet; and another part of the light emitted from the light source assembly directly passes through the optical space and exits through the light outlet.

Beneficial effects: as compared to the other technology, in the lighting apparatus provided by the examples of the present disclosure, the internal surface of the reflecting device includes a plurality of saw-tooth structures arranged continuously, the internal surface is used as a light incident surface and a light emergent surface at the same time, and the external surface is used as a reflecting surface; with such design, all the light incident onto the internal surface can exit with an optical effect of total reflection, so as to improve the luminous efficiency without the need of an electroplating process.

The present disclosure also provides a method of manufacturing a lighting apparatus. The method may include providing a lamp body; connecting an optical element the lamp body; receiving a light source assembly in the lamp body; receiving a reflecting device in the lamp body, wherein the reflecting device is configured to provide: a light distribution for the light source assembly, and a driving power source assembly received in the lamp body and electrically connected with the light source assembly.

The method may also include providing the reflecting device with a light inlet, a light outlet and a reflecting wall located between the light inlet and the light outlet, wherein the reflecting wall is transparent, and the reflecting wall comprises an internal surface and an external surface, where the internal surface may include a plurality of saw-tooth structures arranged continuously, each of the saw-tooth structures may include a first refracting surface and a second refracting surface intersected with each other, and two ends of each of the saw-tooth structures extend towards the light inlet and the light outlet; and disposing the light source assembly at the light inlet of the reflecting device.

The method may further include providing a connecting part sleeved at a periphery of the lamp body and connecting the connecting part the lamp body and the optical element.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

The foregoing particular examples further describe the objects, technical solutions and advantages of the present disclosure in more details. It should be appreciated that, the above merely are particular examples of the present disclosure, but not limitative to the present disclosure. Any modification, equivalent replacement, improvement and the like that is made within the spirit and principle of the present disclosure shall be within the protection scope of the present disclosure.

What is claimed is:

1. A lighting apparatus, comprising a lamp body, an optical element connected with the lamp body, a light source assembly received in the lamp body, a reflecting device received in the lamp body and configured to provide a light distribution for the light source assembly, and a driving power source assembly received in the lamp body and electrically connected with the light source assembly; and wherein:
the reflecting device is provided with a light inlet, a light outlet and a reflecting wall located between the light inlet and the light outlet, the reflecting wall is transparent, and the reflecting wall comprises an internal surface and an external surface;
the internal surface comprises a plurality of saw-tooth structures arranged continuously, each of the saw-tooth structures comprises a first refracting surface and a second refracting surface intersected with each other, and two ends of each of the saw-tooth structures extend towards the light inlet and the light outlet; and
the light source assembly is disposed at the light inlet of the reflecting device.

2. The lighting apparatus according to claim 1, wherein the reflecting device is in an annular shape, and the reflecting device has uniform thickness.

3. The lighting apparatus according to claim 1, wherein the first refracting surface and the second refracting surface are perpendicular to each other.

4. The lighting apparatus according to claim 1, wherein the external surface of the reflecting wall is a smooth wall and is a total reflection wall.

5. The lighting apparatus according to claim 1, wherein a diameter of the light inlet is smaller than a diameter of the light outlet, and the two ends of the saw-tooth structure extend into at least one of the light inlet and the light outlet.

6. The lighting apparatus according to claim 1, wherein the first refracting surface and the second refracting surface of the saw-tooth structure are intersected with each other to generate a ridged line, and the ridged line is a straight line or an arc line.

7. The lighting apparatus according to claim 1, wherein an included angle between a tangent line of any point on the ridged line and a plane where the light inlet is located is smaller than A, wherein A is 40°.

8. The lighting apparatus according to claim 7, wherein, when a material of the reflecting wall is PC, A equals to 38°; and when the material of the reflecting wall is acrylic, A equals to 30°.

9. The lighting apparatus according to claim 1, wherein two reflecting walls opposite to each other are provided, and each of the reflecting walls is in a flat plate shape.

10. The lighting apparatus according to claim 9, wherein the reflecting device further comprises a connecting plate disposed between the reflecting walls.

11. The lighting apparatus according to claim 1, wherein the lighting apparatus further comprises a heat sink received in the lamp body, and both of the light source assembly and the driving power source assembly are received in the heat sink.

12. The lighting apparatus according to claim 11, wherein an upper end face and a lower end face of the heat sink, and/or, an upper surface and a lower surface of the heat sink, are disposed between the optical element and the lamp body in a manner of abutting against the optical element and the lamp body.

13. The lighting apparatus according to claim 1, wherein the light source assembly and the driving power source assembly are disposed integrally or disposed separately.

14. The lighting apparatus according to claim 1, wherein:
the driving power source assembly and the light source assembly are disposed separately;
the driving power source assembly comprises an annular-shaped power source plate and a driving power source located at one side of the power source plate; and
the light source assembly is located at an inner side of the power source plate.

15. The lighting apparatus according to claim 1, wherein:
the lighting apparatus comprises a first staged reflector and a second staged reflector; and
the reflecting device is the first staged reflector, and the optical element is the second staged reflector in a form of reflex housing.

16. The lighting apparatus according to claim 1, wherein the lighting apparatus further comprises a connecting part sleeved at a periphery of the lamp body, and the connecting part is connected with the lamp body and the optical element.

17. The lighting apparatus according to claim 16, wherein the optical element comprises a surface ring and a brightness balance plate located at an inner side of the surface ring.

18. The lighting apparatus according to claim 17, wherein the surface ring comprises a main body in a vertical, circular ring shape, and an annular surface which is connected integrally with the main body and is in a horizontal, circular ring shape;
the main body is connected with the lamp body and the optical element.

19. A method of manufacturing a lighting apparatus, comprising:
providing a lamp body;
connecting an optical element the lamp body;
receiving a light source assembly in the lamp body;
receiving a reflecting device in the lamp body, wherein the reflecting device is configured to provide: a light distribution for the light source assembly, and a driving power source assembly received in the lamp body and electrically connected with the light source assembly;
providing the reflecting device with a light inlet, a light outlet and a reflecting wall located between the light inlet and the light outlet, wherein the reflecting wall is transparent, and the reflecting wall comprises an internal surface and an external surface, wherein the internal surface comprises a plurality of saw-tooth structures arranged continuously, each of the saw-tooth structures comprises a first refracting surface and a second refracting surface intersected with each other, and two ends of each of the saw-tooth structures extend towards the light inlet and the light outlet; and
disposing the light source assembly at the light inlet of the reflecting device.

20. The method according to claim 19, further comprising:
providing a connecting part sleeved at a periphery of the lamp body and
connecting the connecting part the lamp body and the optical element.
